(19) United States
(12) Patent Application Publication
(10) Pub. No.: US 2007/0226649 A1
(43) Pub. Date: Sep. 27, 2007

(54) METHOD FOR PREDICTIVE TYPING

(76) Inventor: Jonathan AGMON, Ra'anana (IL)

Correspondence Address: SOROKER-AGMON ADVOCATE AND PATENT ATTORNEYS, NOLTON HOUSE, 14 SHENKAR STREET, HERZELIYA PITUACH, 46725, omitted

(21) Appl. No.: 11/683,441

(22) Filed: Mar. 8, 2007

(30) Foreign Application Priority Data
Mar. 23, 2006 (IL) 174522

(51) Int. Cl. G06F 3/048; G06F 17/21; G06F 17/27; G06F 17/00

(52) U.S. Cl. 715/816; 715/531; 715/534; 704/9; 704/10

(57) ABSTRACT

A method for suggesting possible completions for a typed text to a user of a device having a reduced keyboard. The possibilities include reference to external data, such as date, time, location and weather, or words related to the last continuation used in the same context, wherein the words are either taken from a general list that is pre-installed in the device, or a user-entered list.

### BACKGROUND OF THE INVENTION

1. Field of the Invention

The present invention relates generally to insertion of text in hand held devices, and more particularly, to a method to enable a more rapid entry of text messages by enabling users of hand held devices using reduced keyboards based on predetermined rules.

2. Discussion of the Related Art

Presently available hand held devices, such as cellular phones and personal data assistance, such as Blackberry devices from RIM, Canada, comprise a reduced keyboard characterized by having a number of letters associated with each key representing a numeric. In alternative devices each key may represent two or more alphabet characters. Thus, for example, the key on a cellular hand held device used for entering a number such as the number “2” will likely comprise an indication for the letters “a”, “b” and “c”. Likewise, other reduced keyboards comprise keys representative of numbers to be dialed also comprise letters thereon. To better enable a quick insertion of words by a user, a predictive text input device which may also comprise a language dictionary therewith can be implemented in the hand held device. Such devices have been described in the prior art. U.S. Pat. No. 3,967,273 discloses method and apparatus for using a pushbutton telephone keyboard in which a signal sequence representing a unique symbol is generated by pushing a first button on which the desired symbol is located, each button being labeled with at most a three by three array of symbols, and pushing a second button, which is indicated by the position of the symbol in the array on the first button. Letters and numbers are arranged corresponding to the arrangement of a standard typewriter keyboard, insuring that anyone familiar with the location of letters and numbers on a typewriter can quickly find the letter on the keyboard. U.S. Pat. No. 5,818,437 discloses a reduced keyboard disambiguating computer. The keyboard has twelve keys, nine of them labeled with numerous letters and other symbols, and those nine plus one more are labeled each with one of the ten digits. Textual entry keystrokes are ambiguous. The user strikes a delimiting “select” key at the end of each word, delimiting a keystroke sequence which could match any of many words with the same number of letters. The keystroke sequence is processed with a complete dictionary, and words which match the sequence of keystrokes are presented to the user in order of decreasing frequency of use. The user selects the desired word. The letters are assigned to the keys in a non-sequential order which reduces chances of ambiguities. The same “select” key is pressed to select the desired word, and spacing between words and punctuation is automatically computed. For words which are not in the dictionary, two keystrokes are entered to specify each letter. The system simultaneously interprets all keystroke sequences as both one stroke per letter and as two strokes per letter. The user selects the desired interpretation. The system also presents to is the user the number which is represented by the sequence of keystrokes for possible selection by the user.

A predictive text input device, such as the T9 predictive text input device and dictionary by Tegic Communications, Inc. is widely implemented on cellular communication devices comprising a reduced keyboard, wherein each key symbolizes a few letters or digits. T9 enables a user to push one or more buttons of a reduced keyboard, without indicating a particular letter or digit from the letters or digits associated with each button, so that the system proposes the relevant words comprising of, or starting with the particular button sequence. Thus for example, if a user enters the letters “H” and then “E” the T9 dictionary will present the user a list comprising the letters “LP” so if selected will comprise the word “HELP” or the letter “R” so if selected will comprise the word “HER” and the like. In practice the predictive text input device is designed to enable the user to enter text faster and with less key strokes. Referring now to FIG. 1 showing a new message window in a viewing device of a wireless device, known in the art. The wireless device generally referenced 100 comprises a keyboard 102 having keys, each of which is assigned a number and multiple letters or other functions. Wireless device 100 further comprises a central processing unit and a memory device (not shown) for storing and executing execution instructions. Wireless device 100 further comprises an antenna 104 for receiving and sending signals to a wireless network. Optionally wireless device 100 comprises other interfaces to a data or audio network for communicating with other wireless or mobile devices as well with other devices capable of processing data or audio signals, including personal computers, personal data assistants, switching devices, and the like. Device 100 further comprises a screen 106 upon which messages, status of the device and the selections of the user are shown. In the present figure a New Message windows is shown, wherein a user of wireless device 100 can insert a new text message. Such text message is like to be sent to another user of a wireless or mobile or other data capable of processing device. Window 108 shows the “TO” field in which the user of the device may enter the number, name or e-mail or other designation of the addressee. The user of device 100 will use keyboard 102 to insert the text message to be sent to another user. Since user 102 is truncated, the user will likely have to select a particular letter using more then one selection of any particular button. Thus, for example to select the letter “R” the user will have to key button 110 three times, wherein the first selection will show the letter “P”, the second selection the letter “Q” and the third selection the requested letter “R”. Once a message is complete the user may use the button SEND 112 to send the message to another user. Since the selection of each button a number of times to obtain a particular desired letter is cumbersome a T9 dictionary can be used to shorten the process of constructing words in the message. Thus, if the user would like to enter the word “SEND” using the T9 dictionary the user may key in the buttons designating the requested word 7, 3, 6, 3 (110, 114, 116, 114). As shown in the figure under discussion the user has keyed the buttons 7, 3, 6 (110, 114, 116) and the T9 dictionary shows the combination of letters most likely sought after by the user 118. The T9 dictionary further provides the user with a window 120 showing additional combinations for the same selection from which the user can select. These can include for the particular exemplary selection the letter combination of “SEN” 122, “PEO” 124, “REM” 126 and the like. If the user will press an additional button, namely the button 114 wishing to complete the word “SEND” the dictionary will likely show the word “SEND” which the user may select using a selection button 128. In presently available T9 installed hand held devices the T9 will also remember previously made selection and thus allow the user to select complete words which have been keyed in previously. For example, if the user has previously entered the words “GOOD MORNING” the device will save a list of words linked associated one with the other. Therefore, in the present example, once a user selected the keys comprising the word “GOOD”, the device will search within a table previously stored in the memory device of the wireless device 100 and show the user the word “MORNING”, allowing the user to quickly select a follow up word previously entered after the word “GOOD”. If the user has sent a message in the morning, which message comprises the words “GOOD MORNING”, said words were entered or selected one after the other, the device will also present the word “MORNING” as an option for selection after word “GOOD” has been selected or keyed in. While the use of such a table quickens the process of selection of words it fails to take account of external factors, such as the time of day, the location of the user and the like. There is therefore a need in the art for a method and device which will enable a quick selection of words in mobile devices based on predetermined and external factors.

### SUMMARY OF THE PRESENT INVENTION

It is an object of the present invention to provide a novel method for typing a message in a device having a reduced keyboard. In accordance with the present invention, there is thus provided a method for suggesting continuations to a message sent from a device, the message comprising typed text, the message possibly addressed to an addressee identified by an identifier, and typed on a reduced keyboard device by a user, the method comprising the steps of: determining whether the typed text creates a context for automatic, semi-automatic or manual completion, retrieving one or more terms, each term can be taken from an external source or from a user-entered list, or the term is the identifier of the addressee; and presenting the user with the at least one term as part of a list of words suggested for the continuation of the message. The method can further comprise a step of retrieving one or more additional terms, or a step of retrieving a term relating to one or more words previously used in a is message typed on the device at an identical or a similar context. Within the method, the term taken from the external source can relate to a date, a time, a location, or weather conditions. Within the method, the typed text can contain the word “GOOD” and the term can be taken from the group of: “NIGHT”; “MORNING”; “EVENING”; or “AFTERNOON”. One or more letters in the typed text or in the term can be a lower case letter. The method can further comprise the step of entering a user-entered list.

Another aspect of the disclosed invention relates to a computer readable storage medium containing a set of instructions for a device having a reduced keyboard used for typing or sending one or more messages addressed to one or more addressees, the set of instructions comprising: determining whether a text typed on the device creates a context for automatic, semi-automatic or manual completion, retrieving one or more terms, each term can be taken from an external source or from a user-entered list, or a term is an identifier of one of the addressees, and presenting a user of the device with the term as part of a list of words suggested for the continuation of the message.

### BRIEF DESCRIPTION OF THE DRAWINGS

The present invention will be understood and appreciated more fully from the following detailed description taken in conjunction with the drawings in which:

FIG. 1 is a schematic illustration of a handheld device having a reduced keyboard; and

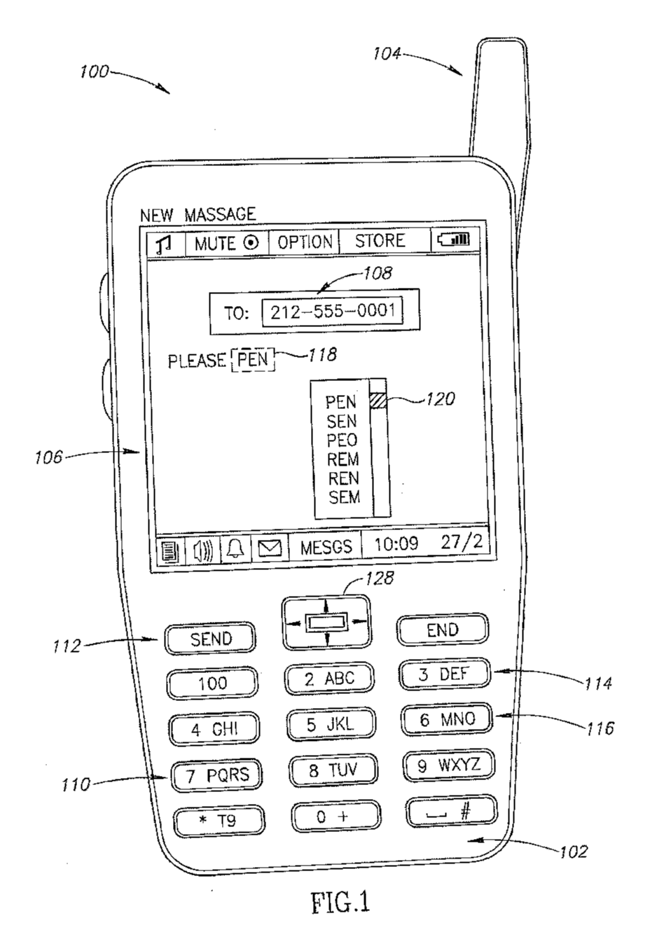

FIG. 2 is a flowchart of the main steps of the disclosed method, in accordance with a preferred embodiment of the disclosed invention.

### DETAILED DESCRIPTION OF THE PREFERRED EMBODIMENT

The present invention overcomes the disadvantages of the prior art by providing a novel method and a system which enable a user to type a message in an efficient manner by taking into account additional data, in addition to the currently available auto continuation methods, such as the T9 method and device, which rely mainly on the previously types word combinations. The additional data can belong to one of a number of predefined categories. The first category is the automatic category, wherein the continuation data is available to the system without user intervention. Such data can relate to the addressee, the date and time, the location, the weather and possibly other known factors associated with the message, the communicating persons, the environment and other parameters. For example, when the word previously typed by the user is likely to be completed by a time-related word, the system will suggest terms taken from a “times” list, which are relevant for the time of the message. For example, if the user previously typed “GOOD MORNING”, and the current time is 4 PM, after typing “GOOD”, the system will suggest as the first option the word “AFTERNOON”, and as a second option the word “MORNING”. Additional options suggested by the system will include other time-related words, such as “NIGHT”. The determination by the device to offer an alternate “time”-related word is based on the fact that the first or one of the words shown for selection in the list is time related. Thus, in the present example, while the user may have previously used the combinations “GOOD DAY”, “GOOD MORNING”, “GOOD MEAL”, the device will identify that the word “GOOD” has been typed and the associated words “DAY”, “MORNING”, “MEAL”, are shown as options for the next word, the system identifies the words associated with the predefined conditions, such as time, and in the present example the word “MORNING” and through examining the internal clock of the device may add to the list the suitable words, such as “AFTERNOON”, “EVENING”, “NIGHT” and the like. Similarly, the current day of week, month or year will be suggested instead of the time used by a user in a past message. For example, if a user typed in a past message the combination “IT IS SUNDAY”, a device implementing the present invention can draw from the internal clock the current day, and suggest it to the user as the first option in the list, and only after that the word “SUNDAY” and the rest of the weekdays. Another automatic category relates to locations, wherein location words such as “in”, or “at”, will cause a device implementing the present invention to suggest the current location of the device. Similarly, weather terms as can be drawn and suggested to the user, for example from a weather source. If a previous word combination stating that the “WEATHER IN XXX IS GOOD” was made, the device will suggest after the words “WEATHER. IN XXX IS” a term corresponding to the current weather conditions in location XXX, or in the current location of the device. A device employing the present invention may send a request to the weather channel (for example at www.weather.com) stating location XXX or the current location of the device and optionally the time, and will receive in return the weather to be displayed as part of the options presented to the user. These options are particularly useful for travelers moving often between places. Yet another automatic category relates to the addressee of the message. If the addressee is known at the time the message is typed, words such as “hi”, “dear” or the like will cause the system to suggest as a first option the name of the addressee, as associated with the number.

Another group of categories relates to semi-automatic lists. These lists include related words, for example synonyms, antonyms, and words in different flections, which are pre-loaded to the device. For example, when the user typed words wherein the next word he typed in a past message following these words was “early”, the system will also suggest the word “late”, “later”, “earlier”, and the like. The implementation of such option can involve importing a dictionary or partial dictionary or a partial thesaurus into the system, either at installation time or as an add-on.

Yet another group of categories relates to manual categories, in which the method uses user-entered lists of related words, so that after typing one of these words in a certain context, when the system suggests this word again, it will also suggest the other words in the list. For example, the list can comprise names of products sold by a sales person, a list of people names, names of places, or the like. The lists of the manual categories can created in the system by using a simple user interface, or by using dedicated software running on any computer and downloaded to the hand held device through a standard communication link, such as USB, infra-red, or the like.

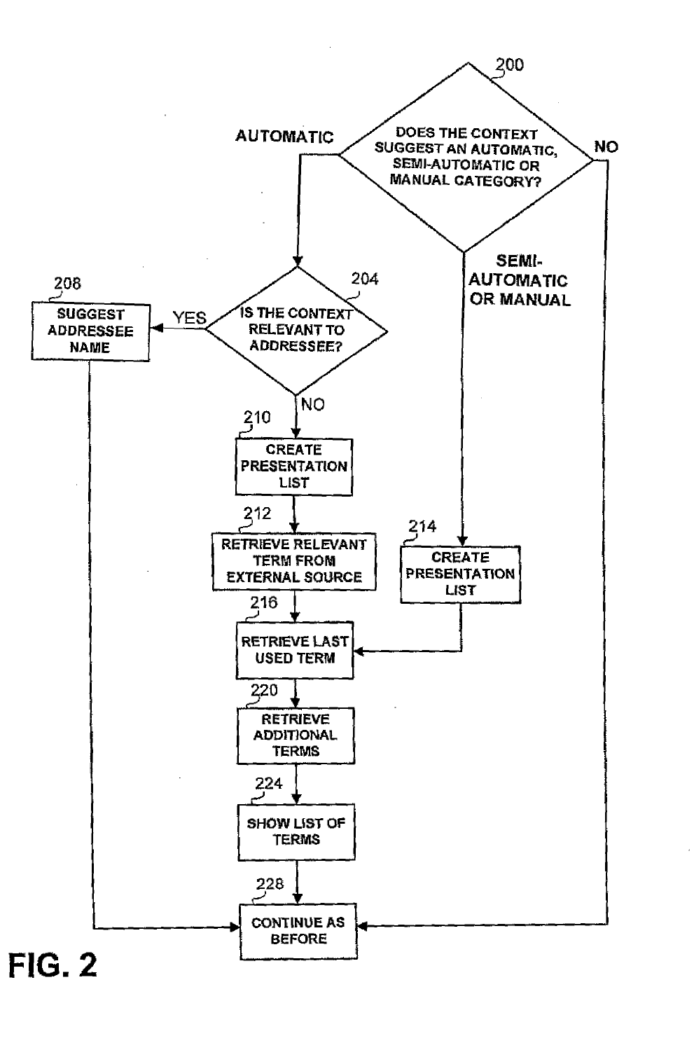

Referring now to FIG. 2, showing a flowchart of the steps associated with a method for implementing the disclosed invention. The method starts at the point where any of the presently available methods considers whether an automatic continuation is appropriate at the current context. At step 200, the method determines according to the typed text whether the context suggests any of the known automatic continuation categories. An automatic continuation category can relate to the addressee, location, weather, time or other factors that are available without user intervention. In such case, the method goes in to determine at step 204 whether the context is relevant to the address. Such situation can occur when the user typed “DEAR”, “HI”, or other addressing terms. In this case, the name of the addressee is suggested at step 208, if available from the number dialed. If the context is not relevant to the addressee, then it is relevant to another automatic category. Then, at step 210, the method creates a presentation lists, and at step 212 places at the top of the list the most appropriate term of the relevant list as retrieved from an external source, for example the time of day, day of week, current location, or the like. At step 216 the last term used in this context is retrieved and added to the presentation list, and at step 220 additional terms are retrieved and added to the presentation list. If the context is manual, the additional terms are retrieved from the user-entered lists; if the context is semi-automatic the additional terms are retrieved a system-list, and if the context is automatic the terms are retrieved as is currently done in known methods, or by retrieving terms from a system list as are relevant for the term retrieved at step 212. The device can sort the presentation list according to various user predefined preferences or according to preset order, such as the following: at the first place, the previously used word, at the second place a retrieved word, and then other words.

At step 224 the user is presented with the presentation list, and chooses the most appropriate option. If, however, at step 200 it is determined that the context creates a semi-automatic or manual category, the method creates a presentation list at step 214, and at step 216 the last term used from the relevant list is retrieved and placed at the top of a presentation list at step 216. The other items of the list are retrieved at step 220 and the list is presented to the user at step 224. At step 228 the method continues as any standard method such as T9, by letting the user select any one or none of the words in the presentation list.

The disclosed invention presents a method for fast and efficient typing when using a reduced keyboard. The method and apparatus provide context-related, user-defined, or externally-deduced possible continuations for typed texts. It will be appreciated by a person having ordinary skill in the art that the suggested division of the method into automatic, semi-automatic and manual continuations is for convenience only and not obligatory, and that different or additional categories can be designed based on the presented principles.

It will be appreciated by a person skilled in the art that although all the examples shown above relate to upper case letters, the method can be used with lower case letters, or any combination of upper and lower case letters.

It will be appreciated by persons skilled in the art that the present invention is not limited to what has been particularly shown and described hereinabove. Rather the scope of the present invention is defined only by the claims which follow.

I/We claim:

1. A method for suggesting continuations to a message sent from a device, said message comprising typed text, said message possibly addressed to an addressee identified by an identifier and typed on a reduced keyboard device by a user, the method comprising the steps of:
determining whether the typed text creates a context for automatic, semi-automatic or manual completion;
retrieving an at least one term, said term is taken from an external source or from a user-entered list, or said term is the identifier of the addressee; and
presenting the user with the at least one term as part of a list of words suggested for the continuation of the message.

2. The method of claim 1 further comprising the step of retrieving an at least one additional term.

3. The method of claim 1 further comprising the step of retrieving a term relating to an at least one word previously used in a message typed on the device at an identical or a similar context.

4. The method of claim 1 wherein the term taken from the external source relates to a date, a time, a location, or weather conditions.

5. The method of claim 1 wherein the typed text contains “GOOD” and the at least one term is taken from the group of: “NIGHT”; “MORNING”; “EVENING”; or “AFTERNOON”.

6. The method of claim 5 wherein one or more letter in the typed text or in the at least one term is a lower case letter.

7. The method of claim 1 further comprising the step of entering a user-entered list.

8. A computer readable storage medium containing a set of instructions for a device having a reduced keyboard used for typing or sending an at least one message addressed to an at least one addressee, the set of instructions comprising:
determining whether a text typed on the device creates a context for automatic, semi-automatic or manual completion;
retrieving an at least one term, said term is taken from an external source or from a user-entered list, or said term is an identifier of the at least one addressee; and
presenting a user of the device with the at least one term as part of a list of words suggested for the continuation of the at least one message.
